(19) United States
(12) Patent Application Publication
(10) Pub. No.: US 2012/0248119 A1
(43) Pub. Date: Oct. 4, 2012

(54) FIXING MODULE AND DEVICE HOUSING USING THE SAME

(75) Inventors: TING-TING ZHAO, Shenzhen City (CN); NA WANG, Shenzhen City (CN); YONG-JUN YU, Shenzhen City (CN); HE-LI WANG, Shenzhen City (CN)

(73) Assignees: HON HAI PRECISION INDUSTRY CO., LTD., New Taipei (TW); HONG FU JIN PRECISION INDUSTRY (ShenZhen) CO., LTD., Shenzhen City (CN)

(21) Appl. No.: 13/150,375

(22) Filed: Jun. 1, 2011

(30) Foreign Application Priority Data
Mar. 31, 2011 (CN) 201110080359.0

(51) Int. Cl. B65D 85/00; B23P 19/00

(52) U.S. Cl. 220/500; 29/700

(57) ABSTRACT

A fixing module used for connecting a first housing to a second housing, includes a first connecting member, a second connecting member, and a fixing member. The first connecting member extends from the inner side of the first housing towards the second housing. The second connecting member extends from the inner side of the second housing towards the first housing, and opposite to the first connecting member. The fixing member is engaged with the first connecting member and the second member, for connecting the first housing to the second housing. A housing with the fixing module is also provided.

### BACKGROUND

1. Technical Field

The present disclosure relates generally to a fixing module used, for example, in a device housing, and a device housing with a fixing module.

2. Description of Related Art

Many housings include a top housing and a bottom housing. Threaded posts are formed on the top housing. Fixing holes are defined in the bottom housing corresponding to the threaded posts. The top housing and the bottom housing are fixed together via many screws being engaged in the threaded posts and the fixing holes. However, in use, the threaded posts are easily damaged, and thus the top housing and the bottom housing become loose. As a result, the electronic components received in the housing may be affected.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of a first embodiment of a device housing.

FIG. 2 is a partial, exploded, isometric view of the device housing of FIG. 1.

FIG. 3 is similar to FIG. 2, but viewed from another aspect.

FIG. 4 is a partial, enlarged, cross-sectional view of the FIG. 1, taken along line IV-IV.

FIG. 5 is a partial, enlarged, cross-sectional view of a second embodiment of a device housing.

### DETAILED DESCRIPTION

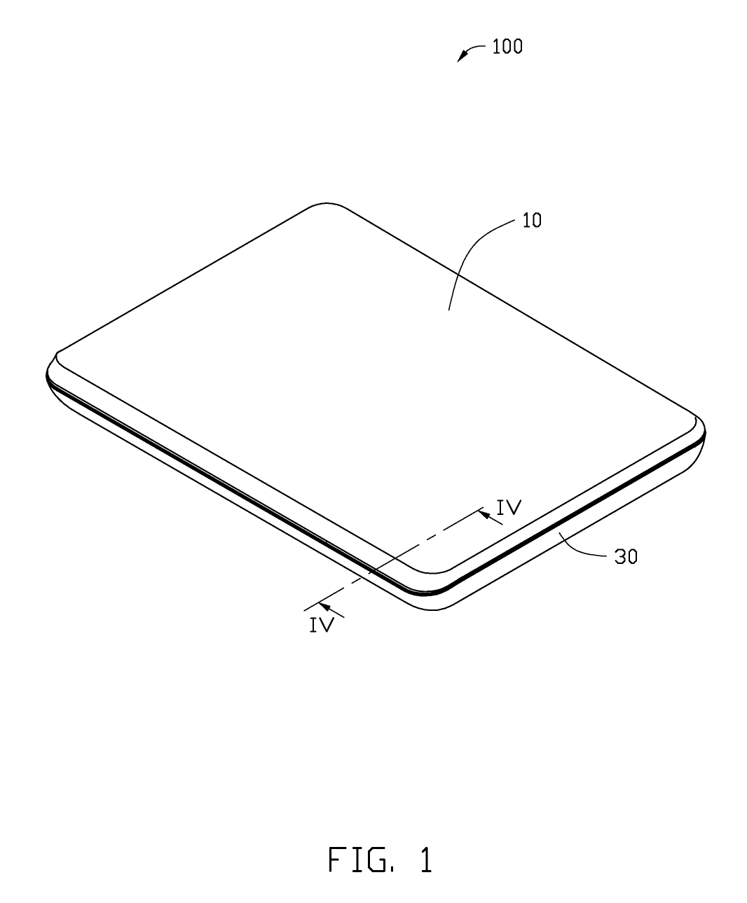

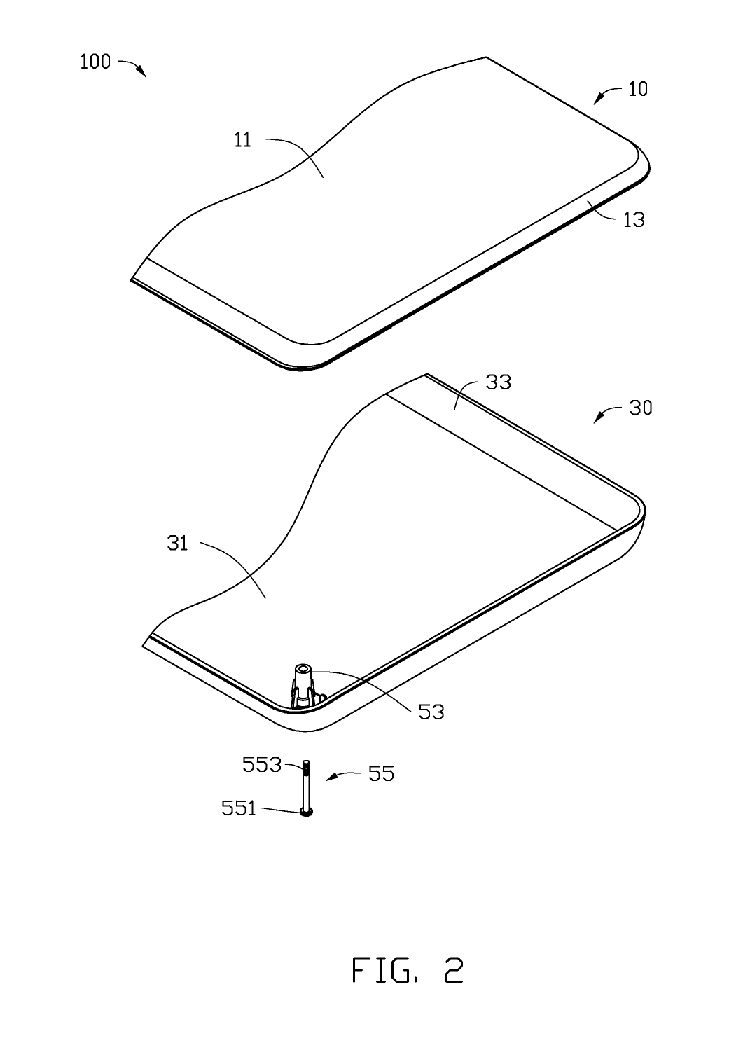

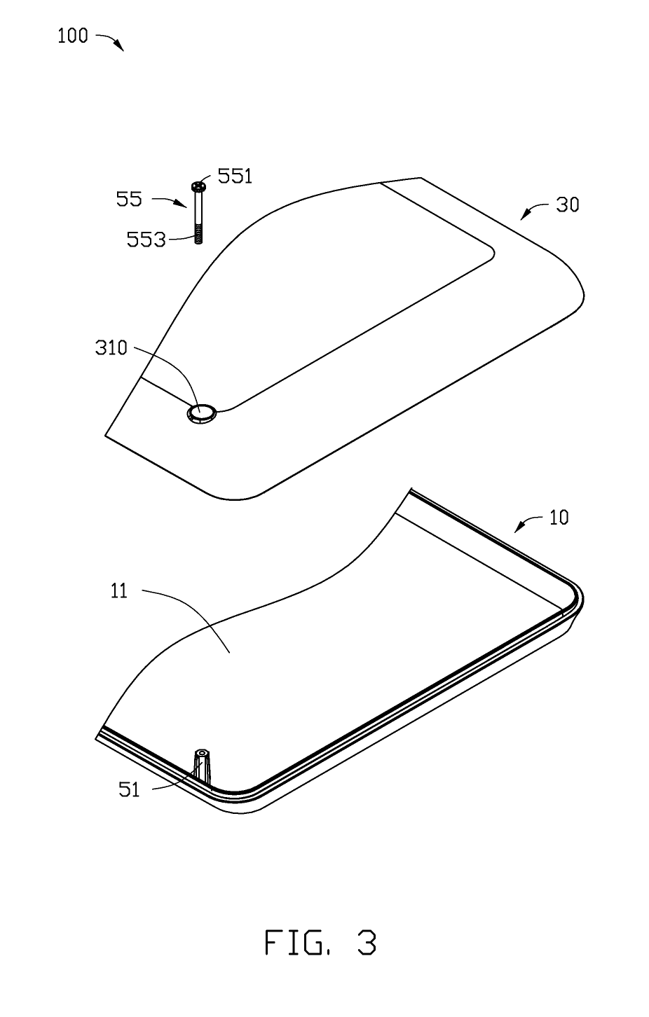

Referring to FIGS. 1 through 4, a first embodiment of a device housing 100 includes a first housing 10, a second housing 30, and a fixing module 50. The first housing 10 and the second housing 30 are fixed together by the fixing module 50, and cooperatively define a receiving space 101.

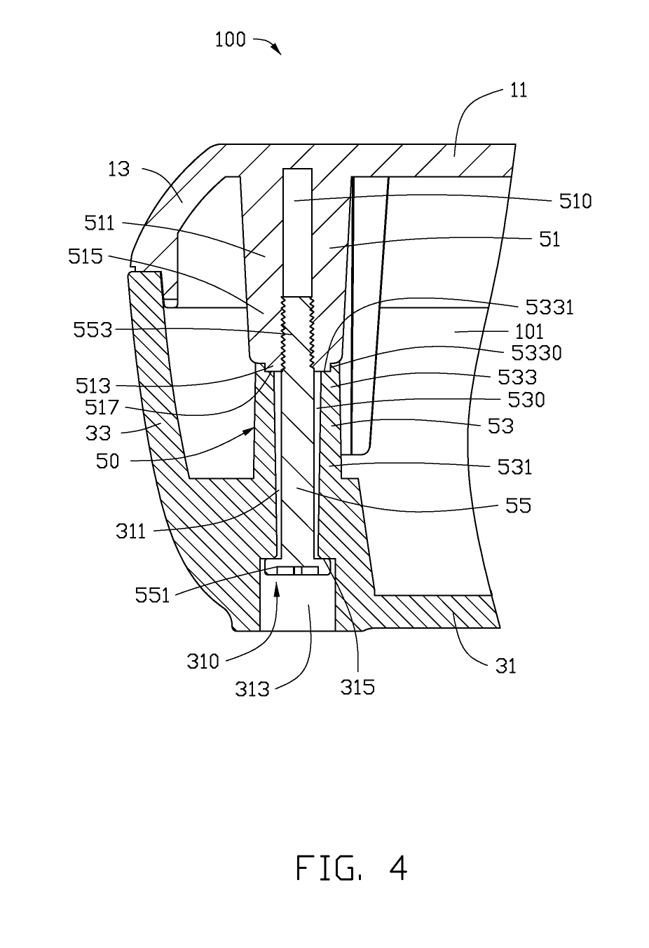

The first housing 10 includes a base 11 and a peripheral wall 13. The peripheral wall 13 extends from the periphery of the base 11. The second housing 30 includes a main body 31 and a wall 33. The wall 33 extends from the periphery of the main body 31. Referring to FIG. 4, one or more circular stepped holes 310 are defined in the main body 31. Each stepped hole 310 includes a first section 311 and a second section 313. The first section 311 is adjacent to the first housing 10, and communicates with the second section 313. A diameter of the first section 311 is smaller than that of the second section 313, such that a step surface 315 is formed between the first section 311 and the second section 313.

The fixing module 50 includes a first connecting member 51, a second connecting member 53, and a fixing member 55. The fixing member 55 engageably connects the first connecting member 51 to the second connecting member 53.

The first connecting member 51 extends from the inner side of the base 11 towards the second housing 30. The first connecting member 51 is substantially cylindrical. A first connecting hole 510 is defined in the center of the first connecting member 51 along the axial direction. The first connecting member 51 includes a connecting portion 511, a positioning portion 513, and a threaded portion 515. The connecting portion 511 is connected to the base 11. The positioning portion 513 is opposite to the connecting portion 511. The threaded portion 515 is sandwiched between the connecting portion 511 and the positioning portion 513. An outer diameter of the positioning portion 513 is smaller than that of the threaded portion 515, such that a stepped positioning surface 517 is formed between the positioning portion 513 and the threaded portion 515. It should be appreciated that the first connecting member 51 is integrally formed on the first housing 10.

The second connecting member 53 extends from an end of the first section 311 of the second housing 30 towards the first housing 10, and opposite and corresponds to the first connecting member 51. A second connecting hole 530 is defined in the center of the second connecting member 53, and communicates with the stepped hole 310. The second connecting hole 530 is aligned and corresponds with the first connecting hole 510. The second connecting member 53 includes a connecting end 531 and an extending end 533. The connecting end 531 is connected to an end of the first section 311. The extending end 533 is opposite to the connecting end 531. A positioning groove 5330 is defined in the extending end 533, such that an engaging surface 5331 is formed. The engaging surface 5331 is engaged with the positioning surface 517, for positioning the first connecting member 51 and the second connecting member 53 during assembly of the device housing 100. It should be appreciated that the second connecting member 53 is integrally formed on the second housing 30.

The fixing member 55 is extended through the stepped hole 310, the first connecting hole 510, and the second connecting hole 530. The fixing member 55 includes an end portion 551 and a threaded portion 553 aligned with the end portion 551. The end portion 551 is received in the second section 313 of the stepped hole 310, and contacts the step surface 315. The threaded portion 553 is engaged with the threaded portion 515 of the first connecting member 51, for fixing the first connecting member 51 to the second connecting member 53.

It should be noted that a plurality of ribs can be formed on the outsides of the first and second connecting members 51, 53 if reinforcement is needed.

A ratio of a length of the first connecting member 51 to a length of the second connecting member 53 along the axial direction is in a range from 0.8 to 1.2, thereby optimizing a length distribution between the first connecting member 51 and the second connecting member 53 to provide greater structural integrity. A ratio of a length of the threaded portion 515 of the first connecting member 51 to a length of the first connecting member 51 is in a range from 0.3 to 0.5 to minimize torsional forces acting on the first connecting member 51.

In the first embodiment, the device housing 100 includes two fixing modules 50. It should be noted that one or more fixing modules 50 can be placed in the device housing 100 when needed.

The following attributes of the device housing 100 contribute to improved structural integrity, stability, and service life of the device housing 100. The fixing module 50 employs the fixing member 55 to connect the first connecting member 51 formed on the first housing 10 to the second connecting member 53 formed on the second housing 30, which thereby avoid forming one connecting member only on one housing of the device housing 100. As a result, a length of the first connecting member 51 or a length of the second connecting member 53 is not too great or large, and therefore structural integrity, stability, and service life of the fixing module 50 are improved. If the first housing 10 and the second housing 30 are made of plastic material, and the first connecting member 51 and the second connecting member 53 are formed by injection molding, issues such as die adhesion, trapped gases, and connect lines can be avoided during molding. If the first housing 10 and the second housing 30 are made of metal, and the first and second connecting members 51,53 are formed by punching, the total number of times for punching in the present embodiment will be relatively less as compared with that currently in the art. As a result, a thickness of the sidewall of the first connecting member 51 and a thickness of the sidewall of the second connecting member 53 can be greater.

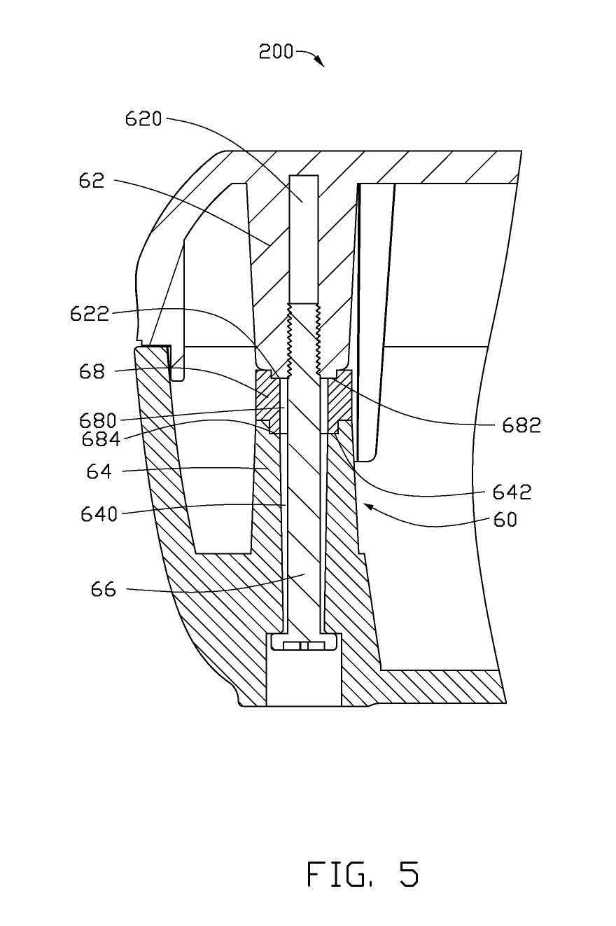

Referring to FIG. 5, a second embodiment of the housing 200 is similar to the first embodiment of the device housing 100. However, a fixing module 60 further includes a third connecting member 68. The third connecting member 68 is sandwiched between the first connecting member 62 and the second connecting member 64. The third connecting member 68 is substantially cylindrical. A third connecting hole 680 is defined in the center of the third connecting member 68 along the axial direction. An engaging surface 682 and a positioning surface 684 are formed on the ends of the third connecting member 68 respectively. The engaging surface 682 is engaged with the positioning surface 622 of the first connecting member 62. The positioning surface 684 is engaged with the engaging surface 642 of the second connecting member 64. The fixing member 66 is extended through the first connecting hole 620, the second connecting hole 640, and the third connecting hole 680, to connect the first connecting member 62, the second connecting member 64, and the third connecting member 68 together.

The fixing module 60 employs the third connecting member 68 which is sandwiched between the first connecting member 62 and the second member 64, and therefore, a length of the first connecting member 62 and a length of the second connecting member 64 are further decreased. As a result, structural integrity, stability, and service life of the fixing module 60 are improved if needed.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A fixing module used for connecting a first housing to a second housing, comprising:
a first connecting member, extending from the inner side of the first housing towards the second housing;
a second connecting member, extending from the inner side of the second housing towards the first housing, and opposite to the first connecting member; and
a fixing member, engaging with the first connecting member and the second member for connecting the first housing to the second housing.

2. The fixing module of claim 1, wherein a first connecting hole is defined in the first connecting member, a second connecting hole is defined in the second connecting member, and aligned with the first connecting hole, and the fixing member is securely received in the first connecting hole and the second connecting hole.

3. The fixing module of claim 2, wherein the first connecting member comprises a positioning portion towards the second connecting member, a stepped positioning surface is formed on the positioning portion, the second connecting member comprises an extending end connected to the positioning portion of the first connecting member, and a positioning groove is defined in the extending end to form an engaging surface engaged with the positioning surface.

4. The fixing module of claim 3, wherein the first connecting member further comprises a connecting portion and a threaded portion, the connecting portion is connected to the first housing, the threaded portion is sandwiched between the connecting portion and the positioning portion.

5. The fixing module of claim 3, wherein the first connecting member and the second connecting member are cylindrical, a ratio of a length of the first connecting member along the axial direction to a length of the second connecting member along the axial direction is in a range from 0.8 to 1.2.

6. A housing, comprising:
a first housing;
a second housing; and
a fixing module, connecting the first housing to the second housing, comprising:
a first connecting member, extending from the inner side of the first housing towards the second housing;
a second connecting member, extending from the inner side of the second housing towards the first housing, and opposite to the first connecting member; and
a fixing member, engaging with the first connecting member and the second member for connecting the first housing to the second housing.

7. The housing of claim 6, wherein a stepped hole is defined in the second housing, and the second connecting member extends from an end of the stepped hole towards the first housing.

8. The housing of claim 7, wherein the stepped hole comprises a first section adjacent to the first housing and a second section communicating with the first section, and thereby a step surface is formed between the first section and the second section, and the fixing member comprises an end portion, the end portion is received in the second section, and contacts the step surface of the second housing.

9. The housing of claim 8, wherein a first connecting hole is defined in the first connecting member, a second connecting hole is defined in the second connecting member, and corresponds to the first connecting hole, the fixing member is extended through in the stepped hole, the first connecting hole, and the second connecting hole.

10. The housing of claim 9, wherein the fixing module further comprises a third connecting member, the third connecting member is sandwiched between the first connecting member and the second connecting member, and the fixing member is extended through the third connecting member and securely connected to the first connecting member and the second connecting member.
